(19) United States
(12) Patent Application Publication
(10) Pub. No.: US 2014/0021123 A1
(43) Pub. Date: Jan. 23, 2014

(54) ADAPTOR AND REVERSE OSMOSIS APPARATUS USING THE SAME

(71) Applicant: Philip Paul Beauchamp, Rexford, NY (US)

(72) Inventor: Philip Paul Beauchamp, Rexford, NY (US)

(73) Assignee: General Electric Company, Schenectady, NY (US)

(21) Appl. No.: 14/110,232

(22) PCT Filed: Apr. 4, 2012
(86) PCT No.: PCT/US12/32119

§ 371 Date: Oct. 7, 2013

(30) Foreign Application Priority Data
Apr. 7, 2011 (CN) 201110086536.5

(51) Int. Cl. B01D 63/10

(52) U.S. Cl. CPC B01D 63/10
USPC 210/321.83; 29/401.1; 285/355

(57) ABSTRACT

An adapter for converting a conventional reverse osmosis apparatus housing to a housing suitable for use with an unconventional spiral flow separator assembly. The adapter comprises a fitting configured to couple a feed inlet of a conventional pressurizable housing detachable first portion to a central core element of an unconventional spiral flow separator assembly. The fitting defines a conduit between an exhaust conduit of the central core element and the feed inlet, and is configured to prevent direct fluid communication between the exhaust conduit of the central core element and a feed surface of the spiral flow separator assembly.

### CROSS-REFERENCE TO RELATED APPLICATIONS

This is a national stage application under 35 USC §371(c) of prior-filed co-pending PCT Application Serial Number PCT/US 2012, 032119, filed on Apr. 4, 2012, which claims priority to CN Application Serial Number 201110086536.6, filed Apr. 7, 2011, the disclosures of which are incorporated in their entirety by reference herein.

### BACKGROUND TO THE INVENTION

This invention generally relates to apparatus and methods that allow unconventional spiral flow separator assemblies to be used in conventional reverse osmosis apparatus housings.

Reverse osmosis apparatus comprising a separator assembly accommodated in a housing have been widely used in various fluid purification processes.

A conventional separator assembly typically comprises a central exhaust conduit and a folded multilayer membrane assembly wound around the central exhaust conduit. The central exhaust conduit comprises two opposite axial ends, and an annular peripheral wall formed with openings. One of the conduit ends is sealed and the other one is unsealed to serve as an exhaust outlet. The folded multilayer membrane assembly comprises a membrane layer having an active surface and a passive surface, a feed carrier layer in contact with the active surface of the membrane layer, and a permeate carrier layer in contact with the passive surface of the membrane layer and the central exhaust conduit, which layers are appropriately folded to prevent bringing the feed carrier layer into contact with the permeate carrier layer or the central exhaust conduit. The folded multilayer membrane assembly wound around the central exhaust conduit forms a cylinder-like resultant structure comprising an annular peripheral surface, a first end surface around the sealed end of the central exhaust conduit, and a second end surface around the unsealed end of the central exhaust conduit, wherein edges of the multilayer membrane assembly at the first and second end surface are appropriately sealed to prevent contact and transmission of the feed solution by the permeate carrier layer, and the annular peripheral surface is also sealed.

During operation, a feed solution containing a solute is fed from the first end surface of the multilayer membrane assembly and is brought into the feed carrier layer, which is in contact with the active surface of the membrane layer. A portion of the feed solution as permeate is transmitted from the active surface of the membrane layer to the passive surface of the membrane layer, and brought into the permeate carrier layer, which is in contact with the central exhaust conduit. The permeate enters the central exhaust conduit through the opening at its annular peripheral wall and flows to the exhaust outlet of the conduit for outputting. The rest of the feed solution which remains within the feed carrier layer, passes in an axially direction through the feed carrier layer and becomes progressively more concentrated as it does so, and subsequently exits the separator assembly as “concentrate” from the second end surface of the folded multilayer membrane assembly.

In use, the conventional separator assembly is accommodated in a conventional housing defining a feed inlet adjacent to the first end surface, a permeate outlet and a concentrate outlet adjacent to the second end surface, and it is installed in a manner such that a feed solution introduced from the feed inlet of the housing enters into the separator assembly from the first end surface thereof, axially passes through the separator assembly, and is separated into a permeate and a concentrate, which emerge from the permeate outlet and concentrate outlet of the housing, respectively.

However, as the feed solution in the conventional separator assembly passes through the assembly along the axis of the assembly, the folded multilayer membrane assembly is especially susceptible to telescoping of the layered structure and consequent contamination of the permeate carrier layer. In addition, weaknesses in the membrane layer occasioned by its folding may result in loss of membrane function leading to uncontrolled contact between the feed solution and the permeate carrier layer. To overcome the aforementioned problems, an unconventional spiral flow separator assembly has been developed to provide alternate configurations not requiring folding of the membrane layers and which provide greater other advantages over conventional separator assemblies. In the spiral flow separator assembly, a feed solution is fed into the assembly from an annular peripheral surface of the assembly, and permeate and concentrate are outputted from two opposite axial ends of the assembly, respectively. Such a spiral flow separator assembly is incompatible with the conventional housing used with conventional separator assemblies. If an end user is to use the new spiral flow separator assembly, the conventional housing would therefore have to be replaced with a pressurizable housing designed for use with the spiral flow separator assembly.

To avoid having the consumer absorb the full cost of purchasing a new housing, there exists a need for apparatus and methods allowing the new spiral flow separator assembly to be used in the conventional housings at a minimal cost.

### BRIEF DESCRIPTION OF THE INVENTION

In an embodiment, the present invention provides an adapter for converting a conventional reverse osmosis apparatus housing to a housing suitable for use with an unconventional spiral flow separator assembly. The adapter comprises a fitting configured to couple a feed inlet of a conventional pressurizable housing detachable first portion to a central core element of an unconventional spiral flow separator assembly. The fitting defines a conduit between an exhaust conduit of the central core element and the feed inlet, and is configured to prevent direct fluid communication between the exhaust conduit of the central core element and a feed surface of the spiral flow separator assembly.

In an embodiment, the present invention provides a method for converting a conventional reverse osmosis apparatus housing to a housing suitable for use with an unconventional spiral flow separator assembly. The method comprises coupling an adaptor to a feed inlet of a conventional pressurizable housing detachable first portion, said adapter comprising a fitting configured to couple a central core element of an unconventional spiral flow separator assembly to the feed inlet, the fitting defining a conduit between an exhaust conduit of the central core element and the feed inlet, the fitting being configured to prevent direct fluid communication between the exhaust conduit of the central core element and a feed surface of the spiral flow separator assembly.

In an embodiment, the present invention provides an adaptor for converting a conventional reverse osmosis apparatus housing to a housing suitable for use with an unconventional spiral flow separator assembly. The adaptor comprises a fitting configured to couple a feed inlet of a conventional housing detachable first portion to a central core element of an unconventional spiral flow separator assembly, and a retainer for securing said fitting to the housing detachable first portion. The fitting defines a conduit between an exhaust conduit of the central core element and an exterior of the conventional housing first portion. The fitting is configured to protrude partially out of the conventional housing from the feed inlet, and is configured to prevent direct fluid communication between the exhaust conduit and a feed surface of the spiral flow separator assembly.

In an embodiment, the present invention provides a pressurizable housing detachable first portion for converting a conventional reverse osmosis apparatus housing to a housing suitable for use with an unconventional spiral flow separator assembly. The detachable first portion comprises a fitting configured to couple with a central core element of an unconventional spiral flow separator assembly. The fitting defining a conduit in fluid communication with an exhaust conduit of the central core element and an exterior of the housing, and is configured to prevent direct fluid communication between the exhaust conduit of the central core element and a feed surface of the spiral flow separator assembly.

These and other features, aspects, and advantages of the present invention may be understood more readily by reference to the following detailed description.

### BRIEF DESCRIPTION OF DRAWINGS

Various features, aspects, and advantages of the present invention will become better understood when the following detailed description is read with reference to the accompanying drawings in which like characters may represent like parts throughout the drawings.

FIG. 1 illustrates the components of a conventional separator assembly and method of its assembly at an intermediate stage.

FIG. 2 illustrates a conventional separator assembly prepared from the intermediate stage structure of FIG. 1.

FIG. 3 illustrates a conventional reverse osmosis apparatus comprising the conventional separator assembly of FIG. 2 accommodated in a conventional housing.

FIG. 4 illustrates an intermediate assembly in the preparation of an unconventional spiral flow separator assembly in accordance with an embodiment of the present invention.

FIG. 5 illustrates a cross-section view at midpoint of an unconventional spiral flow separator assembly prepared from the intermediate structure shown in FIG. 4.

FIG. 6 illustrates a side-on view of an unconventional spiral flow separator assembly in accordance with an embodiment of the present invention.

FIG. 7 illustrates a spiral flow reverse osmosis apparatus comprising an adaptor in accordance with an embodiment of the present invention.

FIG. 8 illustrates a spiral flow reverse osmosis apparatus comprising an adaptor in accordance with an embodiment of the present invention.

FIG. 9 illustrates a spiral flow reverse osmosis apparatus comprising a pressurizable housing detachable first portion for converting a conventional housing to a housing suitable for use with an unconventional spiral flow separator assembly in accordance with an embodiment of the present invention.

### DETAILED DESCRIPTION OF THE INVENTION

In the following specification and the claims, which follow, reference will be made to a number of terms, which shall be defined to have the following meanings In the subsequent description, well-known functions or constructions are not described in detail to avoid obscuring the disclosure in unnecessary detail.

The singular forms “a”, “an”, and “the” include plural referents unless the context clearly dictates otherwise.

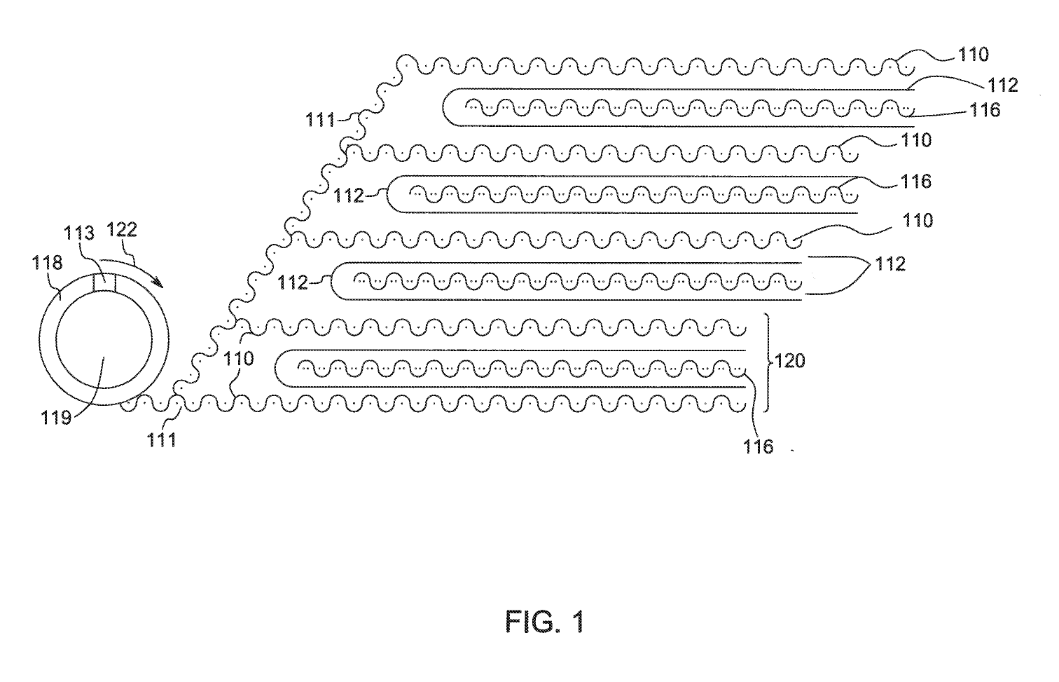

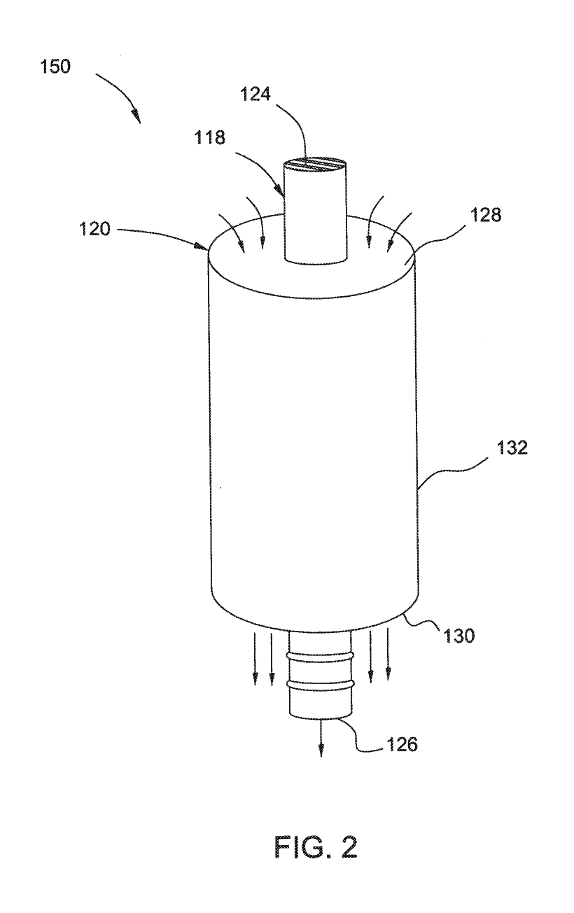

Referring to FIG. 1, the figure represents the components of and method of preparing a conventional separator assembly. In conventional separator assemblies, a membrane stack assembly 120 comprises a folded membrane layer 112 wherein a feed carrier layer 116 is sandwiched between the two halves of the folded membrane layer 112. The folded membrane layer 112 is disposed such that an active surface (not shown in figure) of the folded membrane layer is in contact with the feed carrier layer 116. The folded membrane layer 112 is enveloped by permeate carrier layers 110 such that a passive surface (not shown in figure) of the membrane layer 112 is in contact with the permeate carrier layers 110. Typically, an adhesive sealant (not shown) is used to isolate the feed carrier layer from the permeate carrier layer and prevent direct contact between a feed solution (not shown) and the permeate carrier layer. A plurality of membrane stack assemblies 120, wherein each of the permeate layers 110 is connected to a common permeate carrier layer 111 that is in contact with a permeate exhaust conduit 118 and therefore is in fluid communication with an inner channel 119 of permeate exhaust conduit 118 through openings 113, is wound around the permeate exhaust conduit 118, for example by rotating the permeate exhaust conduit 118 in direction 122, and the resultant wound structure is appropriately sealed to provide a conventional separator assembly 150 as shown in FIG. 2.

Referring to FIG. 2, the exhaust conduit 118 has two opposite ends 124 and 126. The membrane stack assembly 120 wound around the exhaust conduit 118 forms opposite first and second end surfaces 128 and 130 and a sealed annular peripheral surface, referred to at times herein as third surface 132. The exhaust conduit 118 has the end 124 thereof that protrudes from the first end surface 128 closed and the other end 126 thereof that protrudes from the second end surface 130 opened to serve as a conduit outlet. Edges of the membrane stack assembly 120 at the first end surface 128 are appropriately sealed to allow a feed solution to enter the feed carrier layer 116 from the first end surface 128, without entering the permeate carrier layer 110, and edges of the membrane stack assembly 120 at the second end surface 130 are appropriately sealed to allow concentrate from the feed carrier layer 116 but not permeate from the permeate carrier layer to exit from the second surface 130.

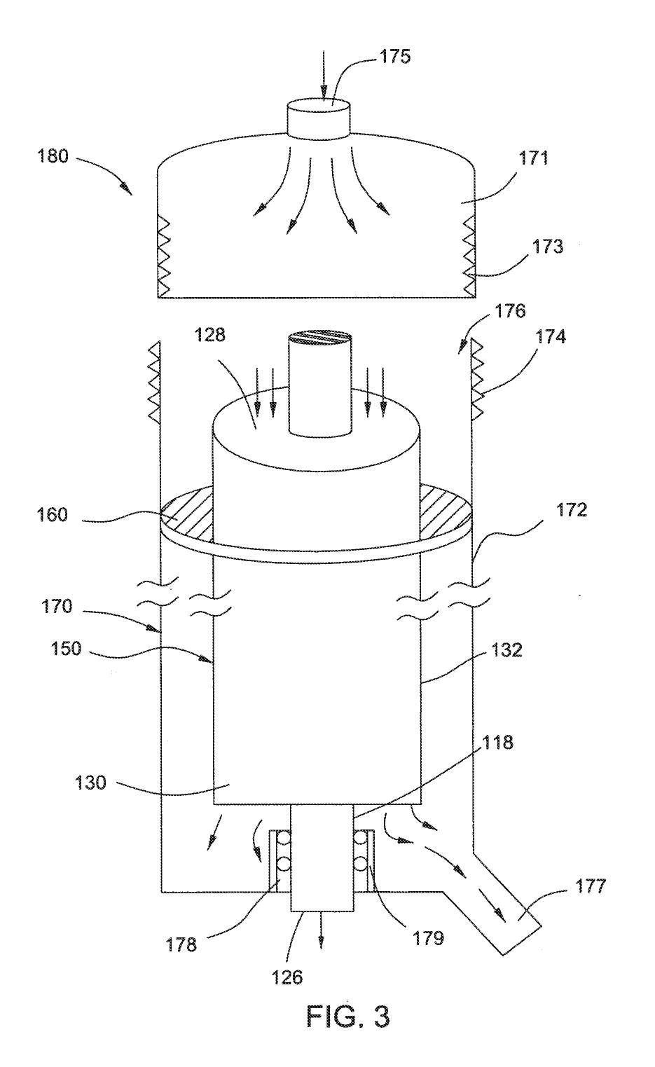

In use, a conventional separator assembly is disposed within a pressurizable housing. Referring to FIG. 3, the conventional separator assembly 150 is accommodated in a conventional pressurizable housing 170 to provide a conventional reverse osmosis apparatus 180. The pressurizable housing 170 comprises a detachable first portion 171 and a detachable second portion 172. The first and second portions 171 and 172 may be joined by means of threads 173 for securing 171 to 172, and threads 174 which are complimentary to threads 173. Other means of securing a detachable first portion of the pressurizable housing to a detachable second portion of the pressurizable housing include the use of snap together elements, gluing, taping, clamping and like means.

The pressurizable housing 170 comprises a feed inlet 175 configured to provide a feed solution to the first end surface 128 of the separator assembly 150. A brine seal 160 is disposed between the third surface 132 of the separator assembly 150 and an inner surface of the housing 170 at a position between the first and second end surfaces 128 and 130 along an axial direction of the separator assembly 150, in order to seal the first end surface 128 from the second end surface 130 and also helps to define a pressurizable sealed volume 176 in fluid communication with the feed inlet 175 and the first end surface 128. The pressurizable housing 170 further comprises a concentrate exhaust outlet 177 in fluid communication with the second end surface 130 of the separator assembly 150 and configured to output the concentrate exiting from the second end surface 130, and a permeate exhaust outlet 178 coupled to the outlet of the permeate exhaust conduit 118. The outlet end 126 of the permeate exhaust conduit 118 is inserted into a coupling member 179 which connects the permeate exhaust conduit 118 to the permeate exhaust outlet 178 of the housing, and thereby secures the separator assembly 150 within the housing 170.

Referring to FIG. 3 in conjunction with FIGS. 1 and 2, during operation, a feed solution containing a solute is fed from the feed inlet 175 and enters the feed carrier layer 116 of the membrane stack assembly 120 from the first end surface 128. A portion of the feed solution as permeate is transmitted from the active surface of the membrane layer 112 to the passive surface of the membrane layer 112, brought into the permeate carrier layer 110, which is in contact with the permeate exhaust conduit 118, and enters the permeate exhaust conduit 118 through the opening 113 at its annular peripheral wall and flows to the conduit outlet 126 where it exits the reverse osmosis apparatus. The rest of the feed solution which remains within the feed carrier layer 116, passes in an axially direction through the feed carrier layer and becomes progressively more concentrated as it does so. “Concentrate” exits the separator assembly 150 from the second end surface 130 and flows to the concentrate exhaust outlet 177 where it exits the reverse osmosis apparatus.

However, in a conventional separator assembly, as the feed solution passes through the assembly along the axial direction of the assembly, the membrane stack assemblies 120 are especially susceptible to telescoping in the direction of flow and in consequence contamination of the permeate carrier layer 110 may result. In addition, weaknesses in the membrane layer 112 occasioned by its folding may result in loss of membrane function leading to uncontrolled contact between the feed solution and the permeate carrier layer 110. To overcome these and other limitations of conventional separator assemblies, unconventional spiral flow separator assemblies, such as those disclosed in U.S. Patent Application No. 2010/0096319 which is herein incorporated in its entirety by reference, have been developed.

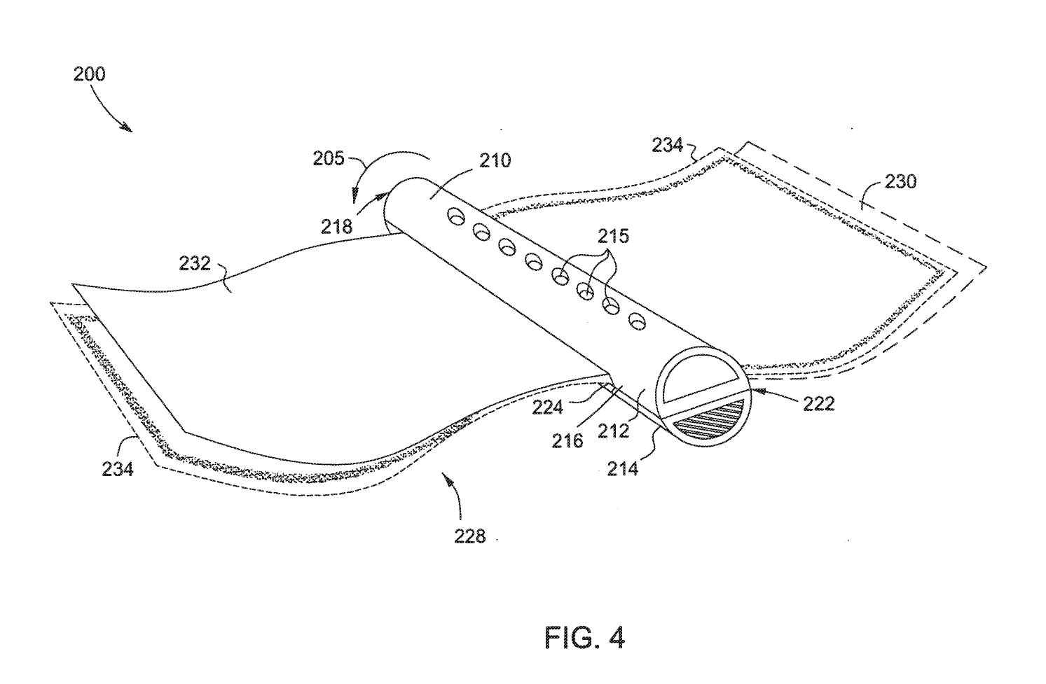

Such unconventional spiral flow separator assemblies 200 are illustrated in FIGS. 4-6. FIG. 4 represents an intermediate assembly in the preparation of one such unconventional separator assembly 200. The spiral flow separator assembly 200 comprises a central core element 210 comprising a permeate exhaust conduit 212 and a concentrate exhaust conduit 214. In the embodiment shown in FIG. 4 the central core element is a separable pair of half cylinders modified by the presence of spacer elements 216. The permeate exhaust conduit 212 comprises openings 215 communicating with the interior channel thereof, and is blocked at one axial end 218. The concentrate exhaust conduit 214 comprises openings (not shown) communicating with the interior channel thereof, and is blocked at end 222. Permeate exits the permeate exhaust conduit 212 from the end 222 while concentrate exits the concentrate exhaust conduit 214 from the end 218. Spacer elements 216 define a cavity 224 which accommodates a first portion of a membrane stack assembly 228 which comprises a feed carrier layer 230 (missing from the left hand side of the figure), a permeate carrier layer 232 (missing from the right hand side of the figure), and a membrane layer 234. A second portion of the membrane stack assembly 228 can be wound around the central core element 210, for example by rotating the central core element 210 in direction 205 to provide the spiral flow separator assembly 200.

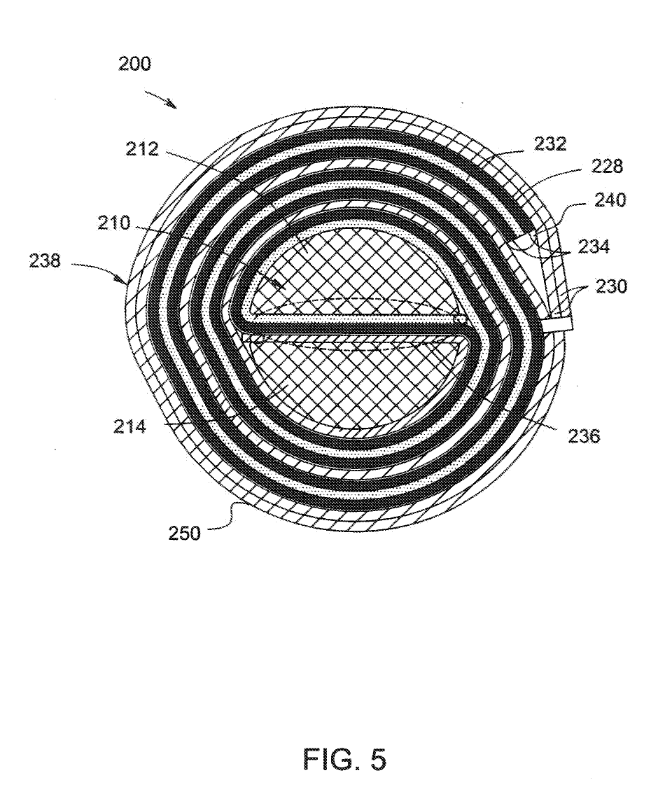

FIG. 5 represents a cross-section view at midpoint of the spiral flow separator assembly 200 and shows the structure of the spiral flow separator assembly 200 after the membrane stack assembly 228 being wound around the central core element 210. As shown in FIG. 5, the permeate exhaust conduit 212 and the concentrate exhaust conduit 214 of the central core element are separated by the first portion 236 of the membrane stack assembly. The second portion of the membrane stack assembly forms a multilayer membrane assembly 238 disposed around the central core element 210. In assembly, the membrane layer 234 is disposed between the feed carrier layer 230 and the permeate carrier layer 232. The feed carrier layer 230 is not in contact with the permeate exhaust conduit 212 or the permeate carrier layer 232, and the permeate carrier layer 232 is not in contact with the concentrate exhaust conduit 214 or the feed carrier layer 230. The ends of membrane stack assembly 228 are secured with sealing portion 240. Sealing portion 240 is a transverse line of sealant (typically a curable glue) which seals the outermost permeate carrier layer 232 to the two adjacent membrane layers 234, said transverse line running the length of the spiral flow separator assembly 200. An exterior annular surface 250 of the spiral flow separator assembly 200 illustrated in FIG. 5 is comprised exclusively of the feed carrier layer 230 which envelops the underlying wound structure.

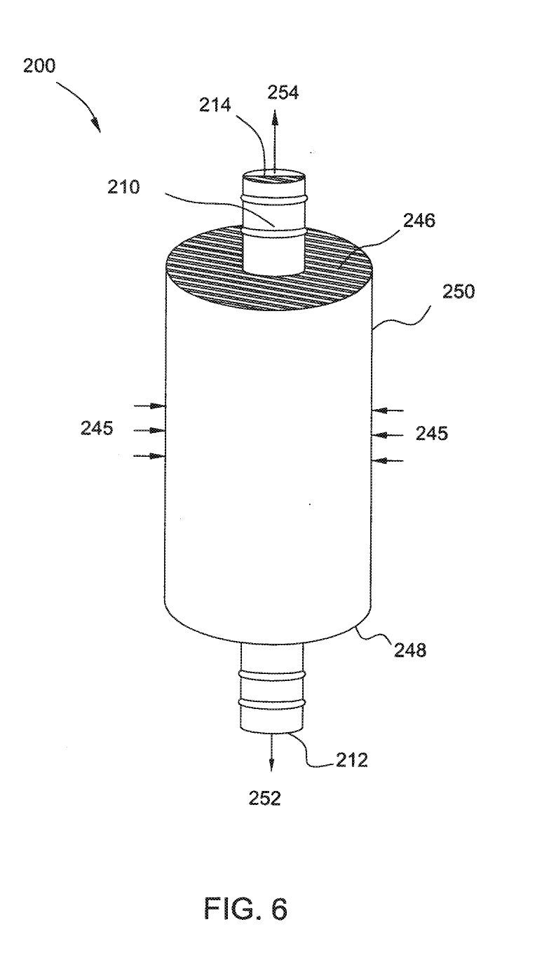

FIG. 6 illustrates a side-on view of the separator assembly 200. The exterior annular surface 250 of the separator assembly 200 serves as a feed surface from which a feed solution containing a solute is fed into the separator assembly 200. The feed solution may enter the separator assembly 200 in directions as indicated by directional arrows 245, for example. The separator assembly 200 comprises sealed first end surface 246 and second end surface 248 which prevent the introduction of feed solution into the separator assembly except at surface 250. Referring to FIGS. 5 and 6, during operation, the feed solution fed from the feed surface 250 is brought into the feed carrier layer 230 of the separator assembly. A portion of the feed solution as permeate is transmitted to the permeate carrier layer 232 through the membrane layer 234, enters the permeate exhaust conduit 212 through openings 215, and flows out of the permeate exhaust conduit 212 in the direction as indicated by arrow 252. The rest of the feed solution which remains within the feed carrier layer, passes through the feed carrier layer in a spiral direction defined by the wound feed carrier layer and becomes progressively more concentrated as it does so, and finally enters into the concentrate exhaust conduit 214 as concentrate and flows out of the concentrate exhaust conduit 214 in direction as indicated by arrow 254. Therefore, the permeate and the concentrate exit the spiral flow separator assembly 200 from two opposite axial ends of the central core element 210, respectively.

Without being limited to the example as illustrated above, the spiral flow separator assembly can be configured as any other suitable structures, for example, which are disclosed in the U.S. Patent Application No. 2010/0096319.

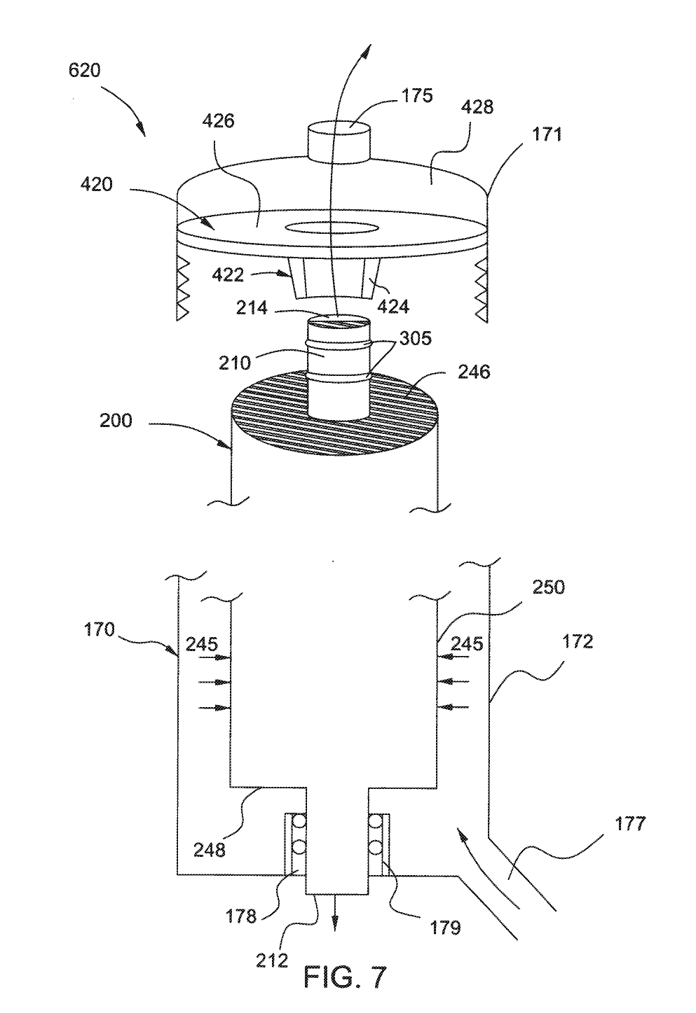

Such unconventional spiral flow separator assemblies are configured differently from conventional separator assemblies, and are incompatible with the conventional housings used with conventional separator assemblies. To allow the spiral flow separator assemblies to be used with the conventional housings and thus avoid the cost designing, manufacturing and installing replacement housings, the present invention provides adapters or detachable housing portions which convert the conventional pressurizable housing to a housing suitable for use with unconventional spiral flow separator assemblies. Embodiments of the adaptors will be described as examples herein below with reference to FIGS. 7-9.

Referring to FIG. 7, in an embodiment, an adaptor 420 for converting a reverse osmosis apparatus conventional housing 170 to a housing suitable for use with a spiral flow separator assembly 200 is provided. The adaptor 420 comprises a fitting 422 configured to couple a feed inlet 175 of a conventional housing detachable first portion 171 to a central core element 210 of an unconventional spiral flow separator assembly 200. The fitting 422 can be secured to the central core element 210 by means of any coupling members, including but not limited to one or more O-rings disposed on an outer surface of the central core element, or complimentary threads disposed upon an outer surface of the central core element and an inner surface of the fitting. The fitting 422 comprises a conduit 424 configured to allow fluid flow between an exhaust conduit of the central core element 210 and the feed inlet 175 of the conventional housing detachable first portion 171. In the illustrated embodiment, the conduit 424 is configured to transport permeate or concentrate from the exhaust conduit to an exhaust volume 428 communicating with the feed inlet 175 of the conventional housing detachable first portion 171, rather than transport permeate or concentrate directly to the feed inlet 175. The fitting 422 further comprises a sealing member 426 configured to prevent direct fluid communication between the exhaust volume 428 and a feed surface 250 of the spiral flow separator assembly 200.

In the illustrated embodiment, the adaptor 420 couples a concentrate exhaust conduit 214 of the central core element to the feed inlet 175 of the conventional housing and converts the feed inlet 175 to be a concentrate exhaust outlet, and a permeate conduit 212 of the central core element is coupled to the permeate exhaust outlet 178 of the conventional housing. Therefore a reverse osmosis apparatus 620 comprising the conventional housing 170, unconventional spiral flow separator assembly 200 and adaptor 420 is provided, and in the reverse osmosis apparatus 620 the feed inlet 175 and concentrate exhaust outlet 177 of the conventional housing 170 are converted to be the concentrate exhaust outlet and feed inlet, respectively.

When the reverse osmosis apparatus 620 is in use, a feed solution is fed into a feed area surrounding the feed surface 250 in the housing 170, from the concentrate exhaust outlet 177 which is converted to be the feed inlet, and is brought into the separator assembly 200 from the feed surface 250. The separator assembly 200 separates the feed solution into permeate and concentrate. Permeate flows through the permeate exhaust conduit 212 and exits from the housing from the permeate exhaust outlet 178 of the housing, and concentrate flows through the concentrate exhaust conduit 214 to the exhaust volume 428 communicating with the feed inlet 175 and is outputted out of the housing from the feed inlet 175 which is converted to be the concentrate exhaust outlet.

In an embodiment, the concentrate exhaust conduit 214 of the central core element 210 is coupled to the permeate exhaust outlet 178 of the conventional housing, and the adaptor is used to couple the permeate exhaust conduit 212 to the feed inlet 175 of the conventional housing.

Comparing with the embodiment in which the adaptor is used to couple the permeate exhaust conduit to the feed inlet of the conventional housing, the pressure differential in the embodiment in which the adaptor is used to couple the concentrate exhaust conduit to the feed inlet of the conventional housing is relatively lower and thus the sealing challenges is relatively smaller.

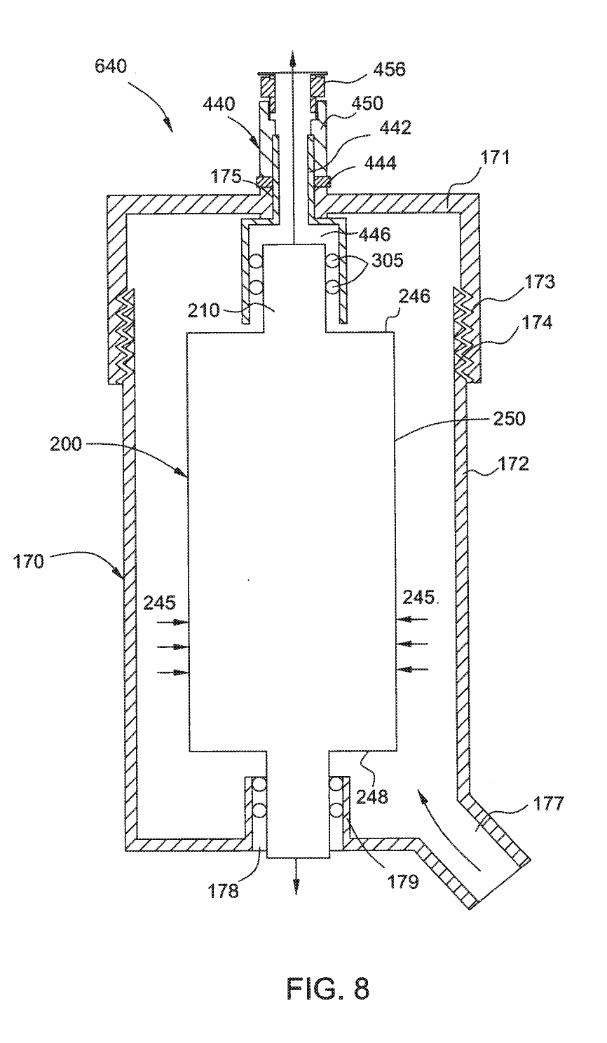

Referring to FIG. 8, in an embodiment, an adaptor 440 is used in another reverse osmosis apparatus 640 for converting a conventional housing 170 to a housing suitable for use with an unconventional spiral flow separator assembly 200. The adaptor 440 comprises a fitting 442 configured to couple a feed inlet 175 of a conventional housing detachable first portion 171 to a central core element 210 of the unconventional spiral flow separator assembly 200. The fitting 422 can be secured to the central core element 210 by means of any coupling members, including but not limited to one or more O-rings 305 disposed on an outer surface of the central core element and an inner surface of the fitting 422, or complimentary threads disposed upon an outer surface of the central core element and an inner surface of the fitting. The fitting 442 protrudes partially out of the conventional housing 170 from the feed inlet 175 and defines a conduit 446 which can be coupled to a concentrate or permeate exhaust conduit of the central core element 210 for transporting permeate or concentrate from the exhaust conduit of the central core element 210 to an exterior of the housing 170, while preventing it from entering a feed surface 250 of the spiral flow separator assembly 200 in the housing 170. The adaptor 440 further comprises a retainer 444 for securing said fitting 442 to the housing detachable first portion 171.

In the illustrated embodiment, the retainer 444 is a retaining nut disposed outside the housing, to secure a first portion of the fitting 442 which protrudes outside the housing, to the housing detachable first portion 171, and the adaptor 440 further comprises a joint 450 for coupling a second portion of the fitting 442 which is protrudes outside the housing, to a commercial spout 456 suitable for use in the reverse osmosis apparatus.

When the reverse osmosis apparatus 640 is in use, a feed solution is fed into a feed area surrounding the feed surface 250 in the housing, from an original concentrate exhaust outlet 177 which is converted to be the feed inlet through the adaptor 440, and is brought into the separator assembly 200 from the feed surface 250. The separator assembly 200 separates the feed solution into permeate and concentrate, which are respectively collected in the permeate and concentrate exhaust conduits of the central core element 210. In an example, the permeate exhaust conduit of the central core element 210 is coupled to a permeate exhaust outlet 178 of the conventional housing and the concentrate exhaust conduit is coupled to the feed inlet 175 via adaptor 440, therefore the permeate is outputted out of the housing from the permeate exhaust outlet 178, and the concentrate flow through the concentrate exhaust conduit to the conduit 446 and is outputted out of the housing from the feed inlet 175 which is converted to be the concentrate exhaust outlet by the adaptor 440. In another example, the concentrate exhaust conduit of the central core element 210 is coupled to the original permeate exhaust outlet 178 of the conventional housing and the permeate exhaust conduit is coupled to the original feed inlet 175 via adaptor 440, therefore the concentrate is outputted from the original permeate exhaust outlet 178 which is converted to be the concentrate exhaust outlet, and the permeate is outputted from the original feed inlet 175 which is converted to be the permeate exhaust outlet by the adaptor 440.

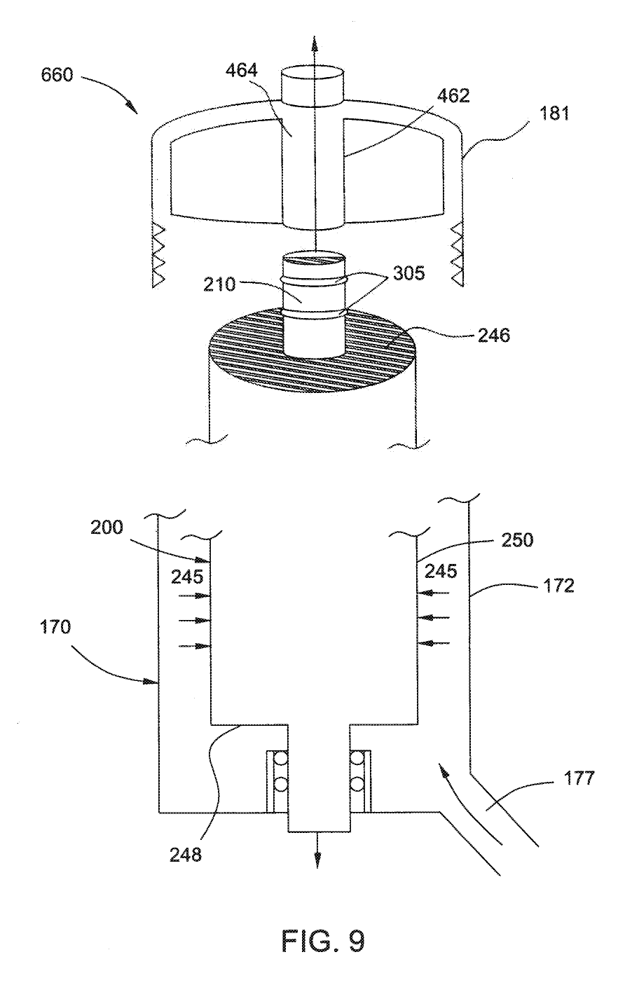

Referring to FIG. 9, an embodiment, a pressurizable housing detachable first portion 181 for converting a conventional housing to a housing suitable for use with an unconventional spiral flow separator assembly is used in a reverse osmosis apparatus 660. The reverse osmosis apparatus 660 comprises a conventional housing detachable second portion 172, a new housing detachable first portion 181 for replacing the original housing detachable first portion, and an unconventional spiral flow separator assembly 200. The housing detachable first portion 181 comprises a fitting 462 configured to couple with a central core element 210 of the unconventional spiral flow separator assembly 200. The fitting 462 can be secured to the central core element 210 by means of any coupling members, including but not limited to one or more O-rings 305 disposed on an outer surface of the central core element and an inner surface of the fitting 462, or complimentary threads disposed upon an outer surface of the central core element and an inner surface of the fitting. The fitting 462 defines a conduit 464 in fluid communication with an exhaust conduit of the central core element 210 and an exterior of the housing, and the fitting 462 is configured to prevent direct fluid communication between the exhaust conduit of the central core element 210 and a feed surface 250 of the spiral flow separator assembly 200.

By replacing the original housing detachable first portion with such a new housing detachable first portion, which enables the detachable second portion 172 of the conventional housing suitable for use with the new spiral flow separator assembly, the consumer can use the new spiral flow separator at a relatively lower cost comparing with replacing the whole conventional housing.

According to an aspect of the present invention, a method for converting a conventional reverse osmosis apparatus housing to a housing suitable for use with an unconventional spiral flow separator assembly is provided by coupling an adaptor as disclosed herein to a feed inlet of a conventional pressurizable housing detachable first portion. The adapter comprises a fitting configured to couple a central core element of the spiral flow separator assembly to the feed inlet of the conventional housing. The fitting defines a conduit between a concentrate or permeate exhaust conduit of the central core element and the feed inlet, converting the feed inlet of the conventional housing to a permeate exhaust outlet or a concentrate exhaust outlet. The fitting is configured to prevent direct fluid communication between the permeate/concentrate exhaust conduit of the central core element and a feed surface of the spiral flow separator assembly, converting a original concentrate exhaust outlet of the conventional housing to a feed inlet.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the subsequent claims.

This written description uses examples to disclose the invention, including the best mode, and to also enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An adapter for converting a conventional reverse osmosis apparatus housing to a housing suitable for use with an unconventional spiral flow separator assembly; said adapter comprising:
a fitting configured to couple a feed inlet of a conventional pressurizable housing detachable first portion to a central core element of an unconventional spiral flow separator assembly, the fitting defining a conduit between an exhaust conduit of the central core element and the feed inlet, the fitting configured to prevent direct fluid communication between the exhaust conduit of the central core element and a feed surface of the spiral flow separator assembly.

2. The adapter according to claim 1, wherein said conduit of said fitting is configured to transport a permeate or concentrate from the separator assembly to an exhaust volume in fluid communication with the feed inlet, and wherein said fitting further comprises a sealing member configured to prevent direct fluid communication between the exhaust volume and the feed surface of the separator assembly.

3. The adaptor according to claim 1, wherein said fitting is configured to protrude from the feed inlet.

4. The adapter according to claim 1, wherein said fitting is configured to couple to a central core element of an unconventional spiral flow separator assembly comprising a permeate exhaust conduit and a concentrate exhaust conduit.

5. The adapter according to claim 1, wherein the fitting is configured to be secured to the central core element by one or more O-rings disposed on an outer surface of the central core element.

6. The adapter according to claim 1, wherein the fitting is configured to be secured to the central core element by complimentary threads disposed upon an outer surface of the central core element and an inner surface of the fitting.

7. A pressurizable housing for a reverse osmosis apparatus comprising the adapter of claim 1.

8. A reverse osmosis apparatus comprising the adaptor of claim 1.

9. A method for converting a conventional reverse osmosis apparatus housing to a housing suitable for use with an unconventional spiral flow separator assembly, said method comprising:
coupling an adaptor to a feed inlet of a conventional pressurizable housing detachable first portion, said adapter comprising a fitting configured to couple a central core element of an unconventional spiral flow separator assembly to the feed inlet, the fitting defining a conduit between an exhaust conduit of the central core element and the feed inlet, the fitting being configured to prevent direct fluid communication between the exhaust conduit of the central core element and a feed surface of the spiral flow separator assembly.

10. An adaptor for converting a conventional reverse osmosis apparatus housing to a housing suitable for use with an unconventional spiral flow separator assembly, said adaptor comprising:
a fitting configured to couple a feed inlet of a conventional housing detachable first portion to a central core element of an unconventional spiral flow separator assembly, the fitting defining a conduit between an exhaust conduit of the central core element and an exterior of the conventional housing first portion, the fitting being configured to protrude partially out of the conventional housing from the feed inlet, the fitting being configured to prevent direct fluid communication between the exhaust conduit and a feed surface of the spiral flow separator assembly; and
a retainer for securing said fitting to the housing detachable first portion.

11. A pressurizable housing for a reverse osmosis apparatus comprising the adapter of claim 10.

12. A pressurizable housing detachable first portion for converting a conventional reverse osmosis apparatus housing to a housing suitable for use with an unconventional spiral flow separator assembly; said detachable first portion comprising:
a fitting configured to couple with a central core element of an unconventional spiral flow separator assembly, the fitting defining a conduit in fluid communication with an exhaust conduit of the central core element and an exterior of the housing, the fitting configured to prevent direct fluid communication between the exhaust conduit of the central core element and a feed surface of the spiral flow separator assembly.
